(19) United States
(12) Patent Application Publication
(10) Pub. No.: US 2023/0336387 A1
(43) Pub. Date: Oct. 19, 2023

(54) COOPERATION WITH DIGITAL FREQUENCY-TRANSLATION REPEATER - GNB AND UE BEHAVIOR

(71) Applicant: MEDIATEK INC., Hsinchu (TW)

(72) Inventor: Lung-Sheng TSAI, Hsinchu (TW)

(21) Appl. No.: 18/127,743

(22) Filed: Mar. 29, 2023

Related U.S. Application Data
(60) Provisional application No. 63/341,439, filed on May 13, 2022.
(60) Provisional application No. 63/331,344, filed on Apr. 15, 2022.

(51) Int. Cl. H04L 27/26

(52) U.S. Cl. CPC H04L 27/26025

(57) ABSTRACT

A UE receives second time domain signals, each carrying L layers of data, in S second intervals corresponding to a second subcarrier spacing. Each of the second intervals contains one or more OFDM symbols. The L layers of data are transmitted by a base station through sets of N₁ modulation symbols carried on N₁ subcarriers of a first subcarrier spacing. The UE obtains sets of N₂ modulation symbols carried on N₂ reception subcarriers of the second subcarrier spacing from each second time domain signal received through each receiving antenna in each second interval. Each set of the sets of N₂ modulation symbols corresponds to one of the OFDM symbols in the S second intervals. The UE obtains a mapping rule that maps the sets of N₂ modulation symbols received in two or more of the S second intervals to a resource set for decoding together.

### CROSS-REFERENCE TO RELATED APPLICATION(S)

This application claims the benefits of U.S. Provisional Application Ser. No. 63/331,344, entitled “COOPERATION WITH DIGITAL FREQUENCY-TRANSLATION REPEATER OVER DIFFERENT FR” and filed on Apr. 15, 2022 and the benefits of U.S. Provisional Application Ser. No. 63/341,439, entitled “UE DESIGN FOR COOPERATION WITH DIGITAL FREQUENCY-TRANSLATION REPEATER OVER DIFFERENT FR” and filed on May 13, 2022. The contents of the application above are expressly incorporated by reference herein in their entirety.

### BACKGROUND

### Field

The present disclosure relates generally to communication systems, and more particularly, to techniques of forming distributed MIMO receivers.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE receives second time domain signals, each carrying L layers of data, through each of Nᵣ receiving antennas on a second frequency band in S second intervals corresponding to a second subcarrier spacing. Each of the second intervals contains one or more OFDM symbols, with Nᵣ and L being positive integers. The L layers of data are transmitted by a base station through sets of N₁ modulation symbols carried on N₁ subcarriers of a first subcarrier spacing. The UE obtains sets of N₂ modulation symbols carried on N₂ reception subcarriers of the second subcarrier spacing from each second time domain signal received through each receiving antenna in each second interval. Each set of the sets of N₂ modulation symbols corresponds to one of the OFDM symbols in the S second intervals. The UE obtains a mapping rule that maps the sets of N₂ modulation symbols received in two or more of the S second intervals to a resource set for decoding together. The UE determines the L layers of data based on the sets of N₂ modulation symbols decoded together as mapped in the resource set.

In another aspect of the disclosure, a method, a computer-readable medium, and an apparatus are provided. The apparatus may be a base station. The base station receives an indication indicating that a UE is capable of receiving data transmitted from the base station on a first frequency band via a group of M wireless devices, each transmitting data on N₂ transmission subcarriers on a second frequency band. The base station transmits, to the UE, L layers of data on N₁ transmission subcarriers on a first frequency band, where L is a positive integer and may be greater than Nᵣ. Nᵣ is the number of receiving antennas that the UE is equipped with on the second frequency band.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating downlink MIMO transmission from a base station to a UE via one or more repeaters.

FIG. 8 is a diagram illustrating RF signal generation at a base station.

FIG. 9 is a diagram illustrating downlink transmission timing from a base station to a UE via one or more repeaters.

FIG. 10 is a diagram illustrating signal transformation at a repeater.

FIG. 11 is a diagram illustrating signal reception at a UE.

FIG. 12 is a flow chart of a method (process) for receiving data signals.

FIG. 13 is a flow chart of a method (process) for transmitting data via a group of M wireless devices

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

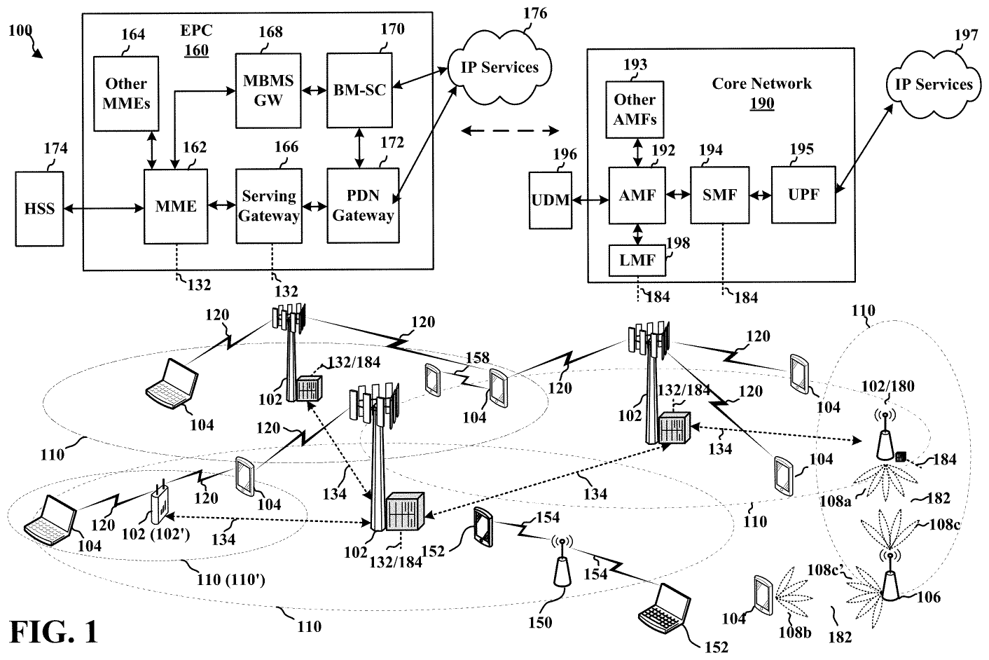

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to X MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

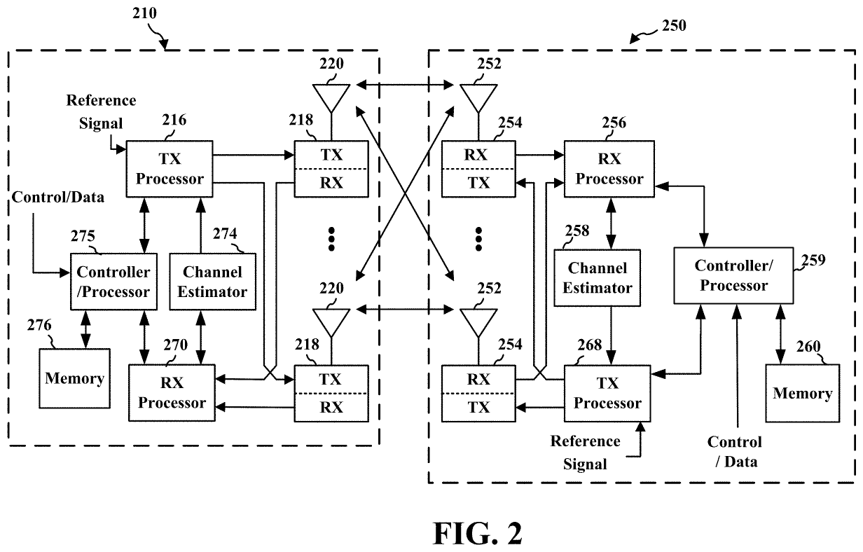

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

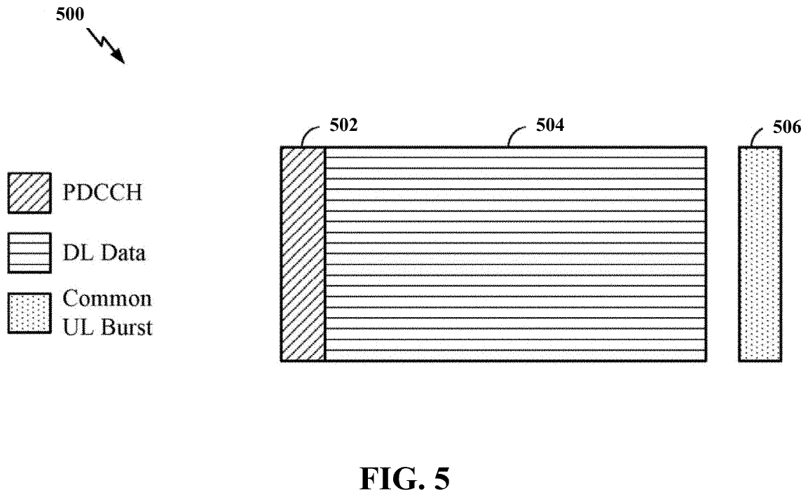

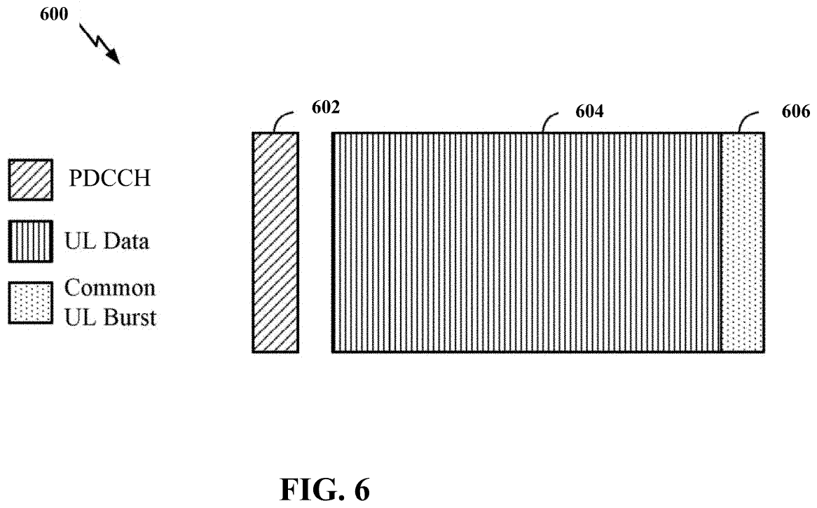

A single component carrier bandwidth of 100 MHz may be supported. In one example, NR resource blocks (RBs) may span 12 sub-carriers for each RB with a sub-carrier spacing (SCS) of 60 kHz over a 0.25 ms duration or a SCS of 30 kHz over a 0.5 ms duration (similarly, 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

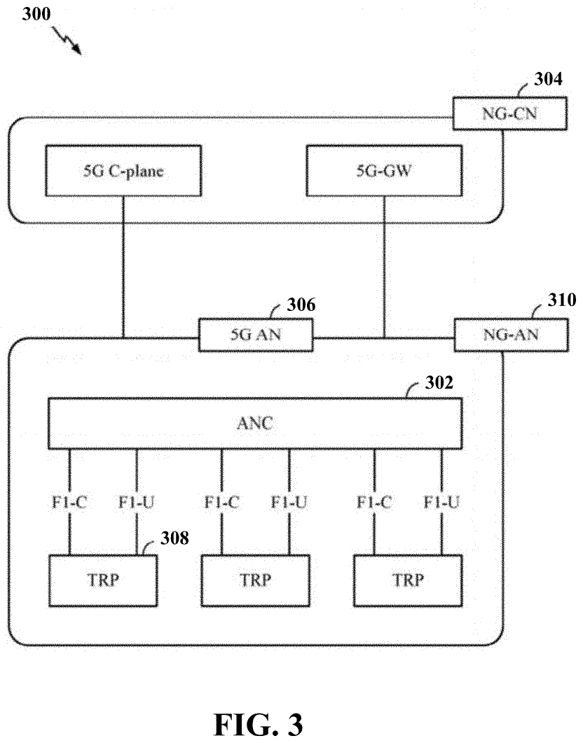

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

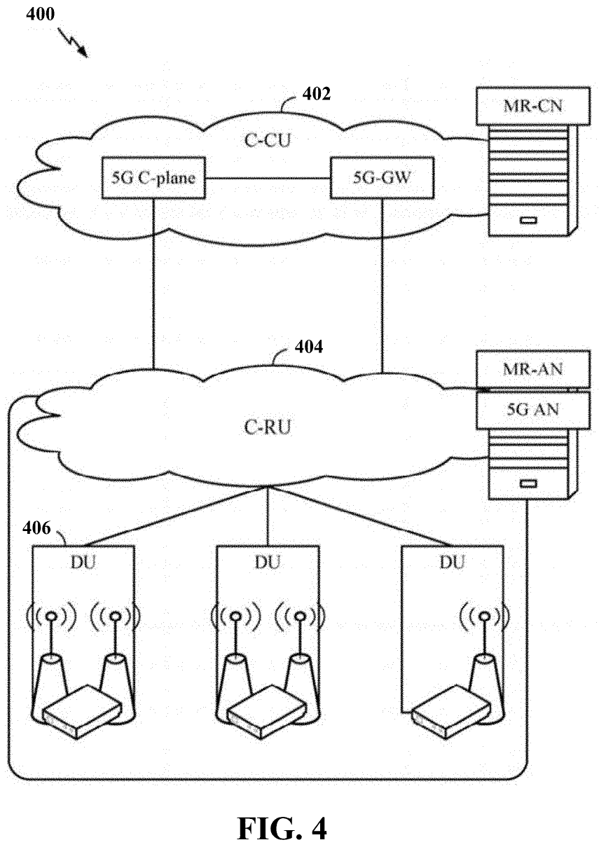

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

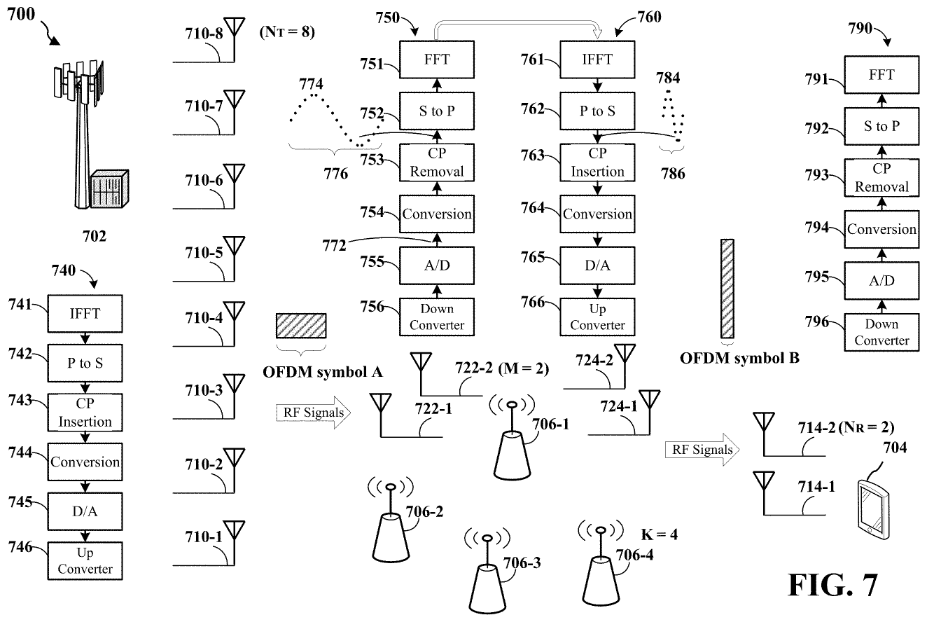

FIG. 7 is a diagram 700 illustrating downlink MIMO transmission from a base station to a UE via one or more repeaters. In this example, a base station 702 has 8 antennas 710-1, 710-2, . . . 710-8, and a UE 704 has 2 reception antennas 714-1, 714-2. Further, repeaters 706-1 . . . 706-K are placed between the base station 702 and the UE 704. In this example, K is 4. Each of the repeaters 706-1 . . . 706-K has two reception antennas 722-1, 722-2 and two transmission antennas 724-1, 724-2. In certain configurations, the same antenna may function as a reception antenna and a transmission antenna.

The base station 702 utilizes a respective transmission chain 740 to generate RF signals to be transmitted at each of the antennas 710-1, 710-2, . . . 710-8. Each transmission chain 740 includes an IFFT component 741, a parallel to serial component 742, a CP insertion component 743, a conversion component 744 that includes a rate converter and/or filter(s), a digital-to-analog converter 745, and an up converter 746.

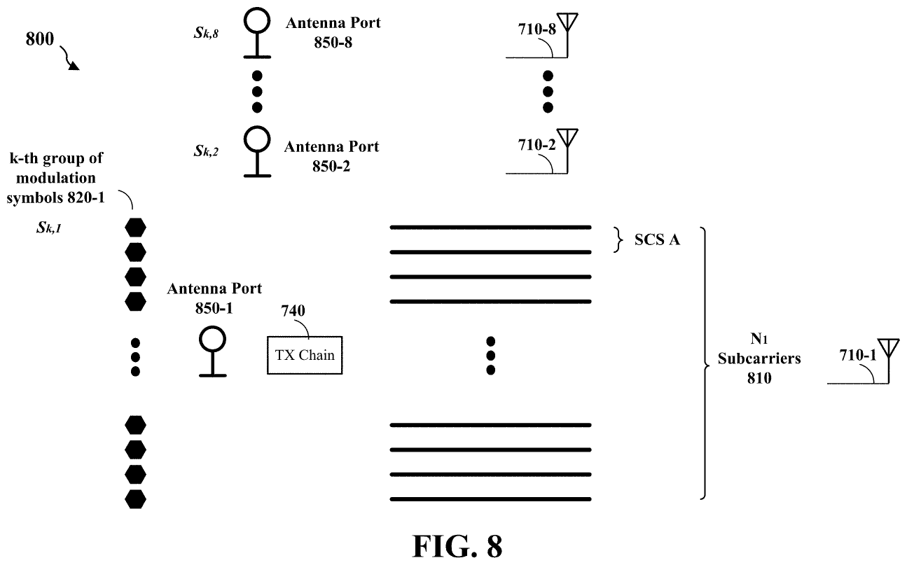

FIG. 8 is a diagram 800 illustrating RF signal generation at a base station. In this example, the base station 702 may be configured with 8 antenna ports 850-1 to 850-8 to each of which one or more of the antennas 710-1, 710-2, . . . 710-8 are assigned. In particular, each of the antenna ports 850-1 to 850-8 may be associated with more than one physical antenna. In such a case, each of the antenna port may be referred to as a beamformed antenna port.

Further, each transmission chain 740 may use N₁ subcarriers 810 (e.g., 1024 or 4096 subcarriers) having a SCS₁ (e.g., 30 KHz). The transmission chain 740 of the antenna 710-i receives, from an i^{th} antenna port, a k^{th} group of N₁ modulation symbols 820-i, denoted as s_{k,i}, and generates corresponding RF signals to be transmitted through the antenna 710-i in an OFDM symbol A, which corresponds to SCS₁. k is the group index of the modulation symbols and i is the index of the antenna port.

Using the antenna 710-1 as an example, that antenna is assigned to the antenna port 850-1. A k^{th} group of N₁ modulation symbols 820-1 from the antenna port 850-1, s_{k,1}, are to be transmitted in one OFDM symbol A through the transmission chain 740. The base station 702 applies s_{k,1} to the N₁ subcarriers 810 in a corresponding time period.

Referring back to FIG. 7, the N₁ subcarriers 810 carrying the N₁ modulation symbols 820-1 are sent to the IFFT component 741 with N₁ inputs. The N₁ time domain signals output from the IFFT component 741 are treated as a time sequence and sent to the parallel to serial component 742 to form a combined time domain signal. The CP insertion component 743 receives the combined time domain signal and adds a cyclic prefix, resulting a time domain signal spanning an OFDM symbol period. The cyclic prefix may eliminate inter-symbol interference between two adjacent OFDM symbols. The resulting time domain signal is in digital form, and processed through the conversion component 744 to achieve a desired sample rate. The converted time domain signal in digital form is sent to the digital-to-analog converter 745, which accordingly generates an analog time domain signal. Subsequently, the up converter 746 receives the analog time domain signal and mixes the analog time domain signal with a first carrier frequency (f₁) to generate a RF signal. The RF signal is transmitted through the antenna 710-1 of the base station 702. In particular, the first carrier frequency of the RF signals transmitted from the base station 702 may be in FR1.

Similarly, each of the antenna ports 850-2 to 850-8 receives respective modulation symbols. A transmission chain 740 assigned to an antenna port accordingly generates corresponding RF signals, which are transmitted through an antenna assigned to that antenna port. As such, in this example, s_{k,1} to s_{k,8} are transmitted through the antennas 710-1, 710-2, . . . 710-8.

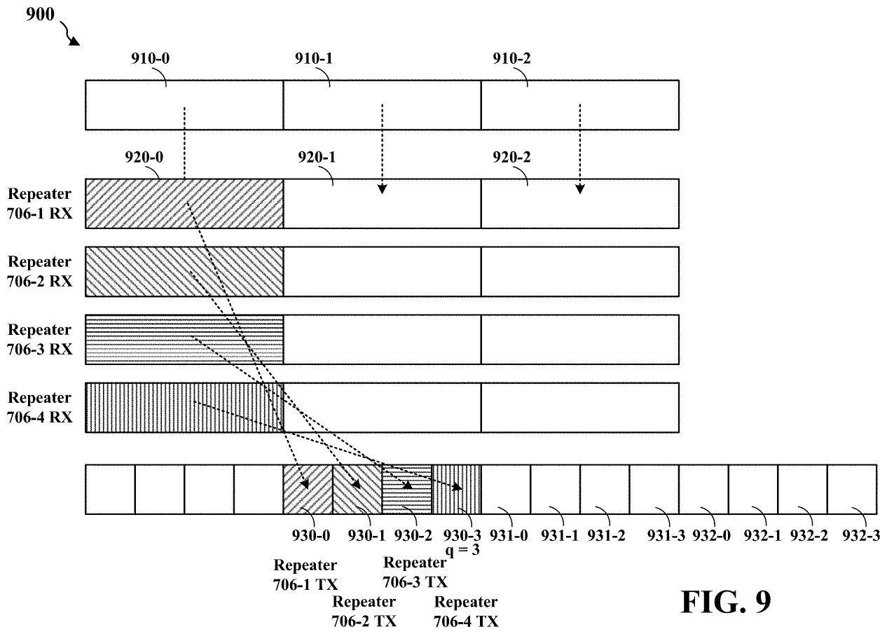

FIG. 9 is a diagram 900 illustrating downlink transmission timing from a base station to a UE via one or more repeaters. The base station 702 transmits, through the antennas 710-1, 710-2, . . . 710-8, RF signals on a first carrier frequency in slots 910-0, 910-1, 910-2, etc. As described infra, the slots 920-0, 920-1, 920-2, etc. are corresponding to a first subcarrier spacing (SCS₁). The repeaters 706-1 . . . 706-K receives the RF signals of the first carrier frequency in the slots 920-0, 920-1, 920-2, etc. The repeaters 706-1 . . . 706-K transform a first set of baseband signals carried on the RF signals of the first carrier frequency to obtain a second set of baseband signals, and transmit the second set of baseband signals over RF signals of a second carrier frequency in slots 930-0, . . . , 930-q, slots 931-0, . . . , 931-q, and slots 932-0, . . . , 932-q, etc. As described infra, the slots 930-0, . . . , 930-q etc. are corresponding to a second subcarrier spacing (SCS₂, e.g., 120 KHz). In NR, a slot may be an interval occupied by 14 OFDM symbols. In this example, q is 3.

The time duration of each of the slots 920-0, 920-1, 920-2, etc. is TTI₁. The time duration of each of the slots 931-0, . . . , 931-q, etc. is TTI₂. Denote L=SCS₂/SCS₁=TTI₁/TTI₂. Denote the first carrier frequency as f₁, and the second carrier frequency as f₂.

The repeaters 706-1 . . . 706-K receive the RF signals of f₁ from the base station 702 in t₀×TTI₁ (e.g., the slot 920-0). Each of the repeaters 706-1 . . . 706-K generates respective RF signals of f₂ as described supra. The eh repeater transmits its RF signals of f₂ in (t₀+offset)×TTI₁+(k−1)×TTI₂ (k=1, . . . , K) (e.g., the slots 930-0, . . . , 930-q). The offset (e.g., 1) is set to provide sufficient time for signal receiving and processing at a repeater.

The number of repeaters 706-1 . . . 706-K (i.e., K) is at most L to utilize the full timing resource for transmission. Accordingly, the UE 704 receives the RF signals at time (t₀+offset)×TTI₁+(k−1)×TTI₂ (k=1, . . . , K).

In this example, the repeaters 706-1 . . . 706-K receives RF signals in the slot 920-0. The repeater 706-1 transmits its RF signals in slot 930-0; the repeater 706-2 transmits its RF signals in slot 930-1; the repeater 706-3 transmits its RF signals in slot 930-2; and the repeater 706-4 transmits its RF signals in slot 930-3.

Referring back to FIG. 7, as described supra, there are K repeaters 706-1 . . . 706-K placed between the base station 702 and the UE 704. In general, a repeater has Mᵣ reception antennas and Mₜ transmission antennas. In this example, for ease of presentation, Mₜ=Mᵣ=M. A single physical antenna may function as both a reception antenna and a transmission antenna. More specifically, M is 2. Each of the repeaters 706-1 . . . 706-K has reception antennas 722-1, 722-2 and transmission antennas 724-1, 724-2.

Each of the repeaters 706-1 . . . 706-K receives RF signals transmitted from the base station 702. For example, each of the reception antennas 722-1, 722-2 of the repeater 706-1 may receive RF signals transmitted from the antennas 710-1, 710-2, . . . 710-8 of the base station 702. A respective reception chain 750 processes RF signals received through each of the reception antennas 722-1, 722-2. The reception chain 750 includes a down converter 756, an analog-to-digital converter 755, a conversion component 754 that includes a rate converter and/or filter(s), a CP removal component 753, a serial to parallel component 752, an FFT component 751.

Using the reception antenna 722-1 as an example, the corresponding down converter 756 processes the RF signals received through that antenna to obtain corresponding analog baseband signals, for example, through frequency down-conversion. The analog-to-digital converter 755 converts the analog baseband signals to digital samples. In particular, to generate the channel signal samples from a baseband waveform, the baseband waveform may be sampled at a rate higher than its Nyquist sampling rate by the analog-to-digital converter 755.

The digital samples are then passed through the conversion component 754, which contains one or more digital filters. The digital filters may perform various functions including I-Q imbalance compensation, carrier synchronization, and/or timing synchronization, etc. to eliminate some imperfections in hardware.

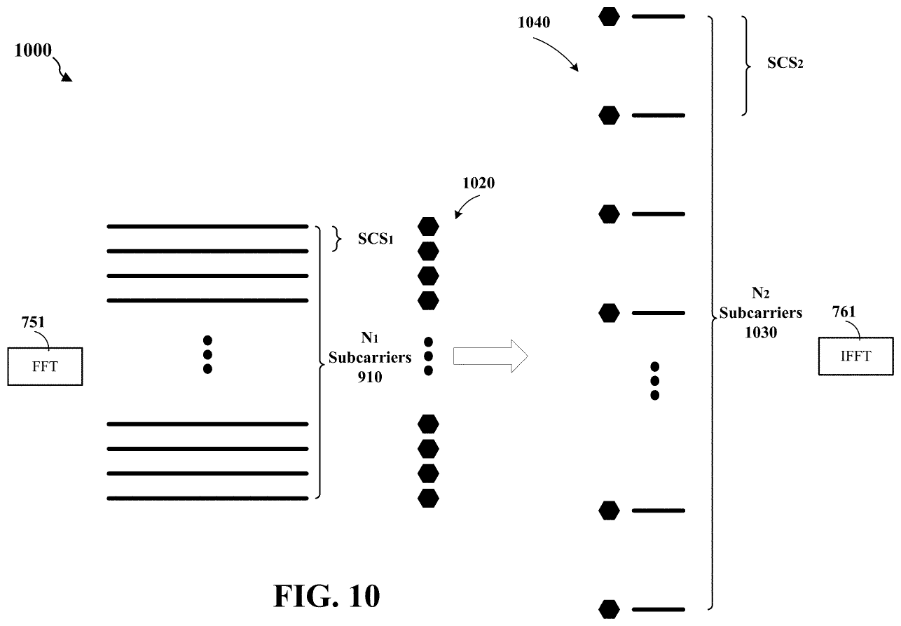

FIG. 10 is a diagram 1000 illustrating signal transformation at a repeater. Using the reception antenna 722-1 of the repeater 706-1 as an example, the FFT component 751 of the reception antenna 722-1 has a size N₁. The filtered digital samples from the conversion component 754 are passed through a down-sampling block, when necessary, to convert the data rate of the digital sample stream to match the FFT size N₁. Accordingly, the positions of the OFDM symbols can be determined in the down converted digital samples. Once digital samples within an OFDM symbol period are found, the CP removal component 753 removes the cyclic prefix (CP) used to prevent inter-symbol interference (ISI). The serial to parallel component 752 groups N₁ data samples as an input vector for the FFT component 751. The FFT component 751 outputs N₁ modulation symbols \tilde{g}_{k,1} 1020, which are a combination of s_{k,1} to s_{k,B} as received at the reception antenna 722-1 of the repeater 706-1. Further, the N₁ modulation symbols \tilde{g}_{k,1} 1020 are carried on N₁ subcarriers 810 with a SCS₁.

As described supra, each of the repeaters 706-1 . . . 706-K has transmission antennas 724-1, 724-2 and uses a respective transmission chain 760 to generate RF signals to be transmitted through each transmission antenna. Further, each transmission chain 760 corresponds to a respective reception chain 750. As described infra, modulation symbols received through a reception antenna of the repeater are retransmitted through a corresponding transmission antenna.

Using the repeater 706-1 as an example (Mᵣ=Mₜ=M=2), the reception antennas 722-1, 722-2 correspond to the transmission antennas 724-1, 724-2. More specifically, \tilde{g}_{k,1} 1020 received through the reception chain 750 of the reception antenna 722-1 are retransmitted through the transmission chain 760 of the transmission antenna 724-1. In a more general case with Mᵣ≠Mₜ, a mapping from the Mₜ transmission antennas to the Mᵣ transmission antennas is needed and may be provided by a linear transformation matrix. In other words, the inputs for retransmitting through the transmission chain 760 of one of the repeater's transmission antennas is linearly combined from \tilde{g}_{k,1} received in one or more of the repeater's Mᵣ reception antennas. If Mᵣ is equal to Mₜ, the linear transformation matrix can be simply an identity matrix representing one-to-one mapping between one reception antenna and one transmission antenna.

The transmission chain 760 uses N₂ subcarriers 1030 having a SCS₂. The IFFT component 761 uses N₂ points and has N₂ inputs/outputs. In one example, N₂≥N₁. The repeater 706-1 is configured with a predetermined rule that maps the N₁ outputs of the FFT component 751 to the N₂ inputs of the IFFT component 761. In particular, each of the N₂ inputs may be a linear combination of the N₁ outputs of the FFT component 751. In one example, the N₁ modulation symbols of \tilde{g}_{k,1} are input through selected N₁ inputs of the N₂ inputs of the IFFT component 761. The remaining (N₂−N₁) inputs of the IFFT component 761 may receive a predetermined value (e.g., 0). The inputs to the IFFT component 761 are N₂ modulation symbols m_{k,1} 1040. m_{k,i} represents the N₂ inputs, of the IFFT component 761 of the i^{th} transmission antenna of a repeater, that are derived from the k^{th} group of modulation symbols transmitted from the base station 702.

More specifically, the repeater 706-1 applies a group of N₂ modulation symbols m_{k,1} 1040 to the N₂ subcarriers 1030 in an OFDM symbol B. The N₂ subcarriers 1030 carrying the N₂ modulation symbols m_{k,1} 1040 are sent to the IFFT component 761 with N₂ inputs. The N₂ digital samples output from the IFFT component 761 are treated as a time sequence and sent to the parallel to serial component 762 to form a time domain signal. The CP insertion component 743 receives the time domain signal and adds a cyclic prefix, resulting a time domain signal spanning an OFDM symbol B, which corresponds to SCS₂. The resulting time domain signal is in digital form, and is processed through a conversion component 764 that includes a rate converter and/or filter(s) to achieve a desired sample rate. The converted time domain signal in digital form is sent to the digital-to-analog converter 765, which accordingly generates an analog time domain signal. Subsequently, the up converter 766 receives the analog time domain signal and mixes the analog time domain signal with a second carrier frequency (f₂) to generate a RF signal. The RF signal is transmitted through the transmission antenna 724-1 of the repeater 706-1. In particular, the second carrier frequency of the RF signals transmitted from the repeaters 706-1 . . . 706-K may be in FR2.

As such, the baseband signal waveform is generated by multiplying OFDM symbols with time-shifted continuous-time pulses. Rate converting and digital low-pass filtering for pulse shaping may be performed before that the digital-to-analog converter 765 generates the waveform. Once the digital-to-analog converter 765 converts the OFDM symbols to an analog waveform, the spectral images can be rejected by using a simple analog filter.

Referring back to FIG. 7, as described supra, the conversion component 754 servicing the reception antenna 722-1 of the repeater 706-1 produces digital samples of the received baseband time domain signal in an OFDM symbol A. The CP removal component 753 removes the CP in the OFDM symbol A and produces digital samples 774 that represent N₁ modulation symbols \tilde{g}_{k,1} 1020. The digital samples 774 occupies a time period 776. The time period 776 and a corresponding CP duration together constitute an OFDM symbol period A.

In a first technique, when N₁=N₂ after obtaining the digital samples 774, the repeater 706-1 may transform the digital samples 774 to generate digital samples 784, and input the digital samples 784 directly into the CP insertion component 763 of the corresponding transmission antenna 724-1. The digital samples 784 represents N₂ modulation symbols m_{k,1} 1040, which are the same as N₁ modulation symbols \tilde{g}_{k,1} 1020 in this example. The digital samples 774, which occupy the time period 776, are compressed into a time period 786. The CP insertion component 763 then adds a corresponding CP to the digital samples 784. The time period 786 and a corresponding CP duration together constitute an OFDM symbol period B. Subsequently, the transmission chain 760 of the transmission antenna 724-1 generates RF signals corresponding to the digital samples 784 as described supra.

In a second technique, using the i^{th} reception antenna and the i^{th} transmission antenna of the repeater 706-1 as an example, the serial to parallel component 752 of a corresponding reception chain 750 receives the digital samples 774 and generates a N₁-element input vector g_{k,i} accordingly. The FFT component 751 receives the g_{k,i} as inputs and produces \tilde{g}_{k,i} as described supra according to: \tilde{g}_{k,i}=FFT_{N}_{₁}(g_{k,i}), where FFT_{N}_{₁}(⋅) denotes the N₁-point FFT function.

The repeater 706-1 can use one of the options described infra to construct m_{k,i}, which are the input vector of the IFFT component 761, based on \tilde{g}_{k,i}. In a first option, the N₁-element vector \tilde{g}_{k,i} is mapped to the centered N₁ subcarriers of the N₂ subcarriers 1030, while the rest of the subcarriers are filled with zeros. This transformation can be represented as:

m_{k,i}=[0_{(N}_{₂}_{-N}_{₁}_{)/2}^{T}\tilde{g}_{k,i}^{T}0_{(N}_{₂}_{-N}_{₁}_{)/2}^{T}]^{T},

where 0_{(N}_{₂}_{-N}_{₁}_{)/2}^{T} is a zero vector of a size (N₂−N₁)/2.

In a second option, the repeater 706-1 maps the j^{th} element of \tilde{g}_{k,i} to the n^{th} element of m_{k,i}, if n=j·R+δ, where R and δ are integers representing the distance and offset, respectively. The rest of the elements of m_{k,i} with an index p, where p≠j R+δ for all j=1, . . . , N₁, are filled with zeros.

In a third option, an element of \tilde{g}_{k,i} can be mapped/copied to multiple elements of m_{k,i}, where each element of m_{k,i} corresponds to an element in \tilde{g}_{k,i}. Therefore, diversity gain can be achieved at the receiver since the information of a symbol in \tilde{g}_{k,i} is carried by multiple subcarriers corresponding to the duplicate elements in m_{k,i}.

Following the options above, to ensure that a UE can successfully decode data signals forwarded by the repeaters, the UE needs one or more parameters indicating mapping of the repeaters such as how the repeater 706-1 maps the N₁ outputs of the FFT component 751 to the N₂ inputs of the IFFT component 761.

Referring back to FIG. 7, as described supra, there are K repeaters 706-1 . . . 706-K placed between the base station 702 and the UE 704. In general, the base station 702 has N_{T} transmission antennas and corresponding N_{T} transmission antenna ports. In this example, N_{T} is 8 (corresponding to the antenna ports 850-1 to 850-8).

As described supra, there are total K repeaters 706-1 . . . 706-K placed in between the base station 702 and the UE 704. Each repeater has M reception antennas/transmission antennas. The base station 702 transmits baseband signals with SCS₁ carried on the first carrier frequency at the N_{T} transmission antennas. The baseband signals correspond to R spatial layers, where R is a positive integer and can be at most equal to the total number of antennas of the repeaters, i.e., K*M. The repeaters 706-1 . . . 706-K receive a first set of baseband signals having N₁ subcarriers of SCS transmitted by the base station 702, and then transform the first set of baseband signals to a second set of baseband signals having N₂ subcarriers of SCS₁. The repeaters 706-1 . . . 706-K transmit the second set of baseband signals to the UE 704 on the second carrier frequency.

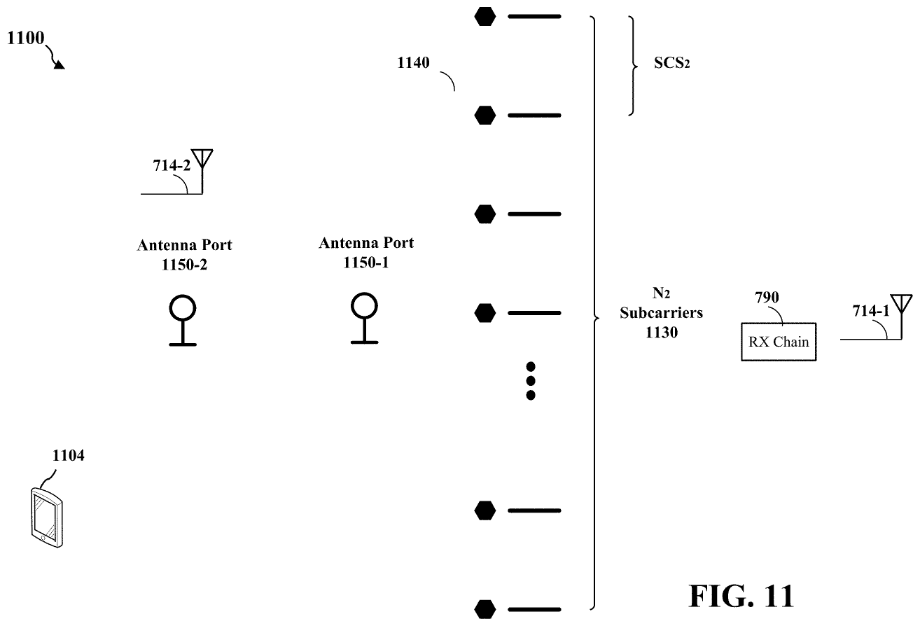

FIG. 11 is a diagram 1100 illustrating signal reception at a UE. In general, the UE 704 may have N_{R}·α reception antennas and corresponding N_{R} reception antenna ports, where each reception antenna port may be associated with one or multiple physical antennas. In such a case, each of the reception antenna port may be preferred to as a beamformed antenna port. In this example in FIG. 11, N_{R} is 2 and α=1. As such, as described supra, the UE 704 has reception antennas 714-1, 714-2. The RF signals received at each reception antenna are processed through a respective reception chain 790. Similar to a reception chain 750 of a repeater, the reception chain 790 includes an FFT component 791, a serial to parallel component 792, a CP removal component 793, filter(s) 794, an analog-to-digital converter 795, and a down converter 796. The UE 704 has antenna ports 1150-1 to 1150-2.

For a given subcarrier, in this example, the base station 702 may generate 8 layers baseband data signals x₁, x₂, . . . , x₈, which can be represented by a vector:

$${x}_{8 \times 1} = [ \begin{matrix}{x}_{1} \\ {x}_{2} \\ ⋮ \\ {x}_{8}\end{matrix} ] .$$

A precoder maps the 8 layers baseband data signals x₁, x₂, . . . , x₈ to the antennas 710-1, 710-2, . . . 710-8, generating 8 superimposed baseband signals s₁, s₂, . . . , s₈ to be transmitted at the antennas 710-1, 710-2, . . . 710-8, respectively. This process can be represented as

$${s}_{8 \times 1} = [ \begin{matrix}{s}_{1} \\ {s}_{2} \\ ⋮ \\ {s}_{8}\end{matrix} ] = {P}_{8 \times 8} [ \begin{matrix}{x}_{1} \\ {x}_{2} \\ ⋮ \\ {x}_{8}\end{matrix} ] .$$

The 8 superimposed baseband signals s₁, s₂, . . . , s₈ are mixed with RF carriers to generate 8 RF signals, which are to then transmitted at the antennas 710-1, 710-2, . . . 710-8.

The channels between the base station 702 and the repeaters 706-1 . . . 706-4 are denoted as H₁_{_{2×8}}⁽¹⁾, . . . , H₄_{_{2×8}}⁽¹⁾, respectively. The channels between the repeaters 706-1 . . . 706-4 and the UE 704 are denoted as H₁_{_{2×8}}⁽²⁾, . . . , H₄_{_{2×8}}⁽²⁾, respectively. Accordingly, on a given subcarrier, the baseband signals received by the UE 704 in the slot 930-1 from the repeater 706-k can be represented as:

rₖ_{_{2×1}}=Hₖ_{_{2×2}}⁽²⁾TₖHₖ_{_{2×8}}⁽¹⁾·P_{8×8}·x_{8×1},k∈{1,2,3,4}.

The UE 704 processes the baseband signals received in the slots 930-0, . . . , 930-4 from the repeaters 706-1 . . . 706-4 together as follows:

$${r}_{8 \times 1} = [ \begin{matrix}{r}_{{1}_{2 \times 1}} \\ {r}_{{2}_{2 \times 1}} \\ {r}_{{3}_{2 \times 1}} \\ {r}_{{4}_{2 \times 1}}\end{matrix} ] = [ \begin{matrix}{{H}_{{1}_{2 \times 2}}^{( 2 )} {T}_{1} {H}_{{1}_{2 \times 8}}^{( 1 )} \cdot {P}_{8 \times 8} ]}_{2 \times 8} \\ {{H}_{{2}_{2 \times 2}}^{( 2 )} {T}_{2} {H}_{{2}_{2 \times 8}}^{( 1 )} \cdot {P}_{8 \times 8} ]}_{2 \times 8} \\ {{H}_{{3}_{2 \times 2}}^{( 2 )} {T}_{3} {H}_{{3}_{2 \times 8}}^{( 1 )} \cdot {P}_{8 \times 8} ]}_{2 \times 8} \\ {{H}_{{4}_{2 \times 2}}^{( 2 )} {T}_{4} {H}_{{4}_{2 \times 8}}^{( 1 )} \cdot {P}_{8 \times 8} ]}_{2 \times 8}\end{matrix} ] \cdot {x}_{8 \times 1}$$

In general, the baseband signals received by the UE 704 from the k^{th} repeater on the n^{th} subcarrier can be expressed as r_{k,n}∈ [symbol] ^{N}^{_{R}}^{×1}

r_{k,n}=H_{k,n}⁽²⁾T_{k,n}H_{k,n}⁽¹⁾·Pₙ·xₙ+n_{k,n}.

n indicates that the associated variable is for the n^{th} subcarrier. H_{k,n}⁽²⁾∈ [symbol] ^{N}^{_{R}}^{×M} denotes the channel matrix from the k^{th} repeater (repeater 706-k) to the UE 704. H_{k,n}⁽¹⁾∈ [symbol] ^{M×N}^{_{T}} denotes the channel matrix from the base station 702 to the k^{th} repeater (repeater 706-k). T_{(k,n)} is an amplifying matrix describing the mapping from the repeater input to the repeater output. For a more general case where each repeater has Mᵣ reception antennas and Mₜ transmit antennas, the dimension of T_{(k,n)} is Mₜ-by-Mᵣ, H_{k,n}⁽²⁾∈ [symbol] ^{N}^{_{R}}^{×M}^{ₜ} and H_{k,n}⁽¹⁾∈ [symbol] ^{M}^{ᵣ}^{×N}^{_{T}}. xₙ∈ [symbol] ^{(R×1)} and Pₙ∈ [symbol] ^{(N}^{_{T}}^{×R)} represent the baseband data signals to be sent by the base station 702 and the precoding matrix at the base station 702, respectively. n_{(k,n)}∈ [symbol] ^{(N}^{_{R}}^{×1)} is the equivalent noise vector at the UE 704 which may contain the noise received at the k^{th} repeater and the UE 704. The UE 704 may process the baseband signals rₙ∈ [symbol] ^{(N}^{_{R}}^{×1)} received from the repeaters 706-1 . . . 706-K in separate slots together (in parallel) as follows:

$${r}_{n} = [ \begin{matrix}{r}_{1 , n} \\ {r}_{2 , n} \\ ⋮ \\ {r}_{K , n}\end{matrix} ] = [ \begin{matrix}{H}_{1 , n}^{( 2 )} {T}_{1 , n} {H}_{1 , n}^{( 1 )} \\ {H}_{2 , n}^{( 2 )} {T}_{2 , n} {H}_{2 , n}^{( 1 )} \\ ⋮ \\ {H}_{K , n}^{( 2 )} {T}_{K , n} {H}_{K , n}^{( 1 )}\end{matrix} ] {P}_{n} {x}_{n} + [ \begin{matrix}{n}_{1 , n} \\ {n}_{2 , n} \\ ⋮ \\ {n}_{K , n}\end{matrix} ]$$

The UE 704 may decode the baseband signals received from the repeaters 706-1 . . . 706-K jointly as described supra. The UE 704 jointly decodes at most KN_{R} layers of data over the received signals rₙ from the K repeaters 706-1 . . . 706-K. This may provide better decoding performance. The UE 704 may also decode the baseband signals received from each of the repeaters 706-1 . . . 706-K individually. At most N_{R} layers of data can be decoded from the received signal r_{k,n} at each TTI₂.

In another example, the base station 702 transmits RF signals, through the antennas 710-1, 710-2, . . . 710-8, representing 2 layers of data x₁_{_{2×1}}, RF signals representing 2 layers of data x₂_{_{2×1}}, RF signals representing 2 layers of data x₃_{_{2×1}}, RF signals representing 2 layers of data x₄_{_{2×1}} concurrently in the slot 920-0. Further, x₁_{_{2×1}}, x₂_{_{2×1}}, x₃_{_{2×1}}, x₄_{_{2×1}} may be mapped by precoders P₁_{_{8×2}}, P₂_{_{8×2}}, P₃_{_{8×2}}, P₄_{_{8×2}} to certain antennas of the antennas 710-1, 710-2, . . . 710-8 that form transmission beams directed to the repeaters 706-1 . . . 706-4, respectively. As such, the beams formed by the antennas 710-1, 710-2, . . . 710-8 directed to one repeater does not significantly interfere with beams directed to other repeaters by properly designing the precoders P₁_{_{8×2}}, P₂_{_{8×2}}, P₃_{_{8×2}}, P₄_{_{8×2}}.

As such, the UE 704 receives r₁_{_{2×1}} in the slot 930-0 as follows:

r₁_{_{2×1}}=[H₁_{_{2×2}}⁽²⁾T₁H₁_{_{2×8}}⁽¹⁾·P₁_{_{8×2}}]_{2×2}·x₁_{_{2×1}}.

The UE 704 receives r₂_{_{2×1}} in the slot 930-1 as follows:

r₂_{_{2×1}}=[H₂_{_{2×2}}⁽²⁾T₂H₂_{_{2×8}}⁽¹⁾·P₂_{_{8×2}}]_{2×2}·x₂_{_{2×1}}.

The UE 704 receives r₃_{_{2×1}} in the slot 930-2 as follows:

r₃_{_{2×1}}=[H₃_{_{2×2}}⁽²⁾T₃H₃_{_{2×8}}⁽¹⁾·P₃_{_{8×2}}]_{2×2}·x₃_{_{2×1}}.

The UE 704 receives r₄_{_{2×1}} in the slot 930-3 as follows:

r₄_{_{2×1}}=[H₄_{_{2×2}}⁽²⁾T₄H₄_{_{2×8}}⁽¹⁾·P₄_{_{8×2}}]_{2×2}·x₄_{_{2×1}}.

Individual decoding at most 2 layers in each of the slot 930-0, . . . , 930-3 can be feasible if the precoders P₁_{_{8×2}}, P₂_{_{8×2}}, P₃_{_{8×2}}, P₄_{_{8×2}} are well designed; for example, ZF precoders commonly used for MU-MIMO can be used. It leads to less MIMO decoding complexity comparing to jointly decoding of 8 layers across the slots 930-0, . . . , and 930-3.

The number of spatial layers R of data transmitted by the base station 702 in each TTI₁ can be at most equal to min{N_{T}, KM, KN_{R}}. To enable the base station 702 to transmit a rank-R signal, the UE 704 is configured to process the signals transmitted by the repeaters 706-1 . . . 706-K and carrying the same data vector xₙ∈ [symbol] ^{(R×1)}.

Further, the base station 702 and the UE 704 adopts the corresponding encoding and decoding methods (i.e., jointly or individually). To decode the R-layer signals transmitted from the base station 702, the UE 704 is configured with necessary parameters that are used at the base station 702 and the repeaters 706-1 . . . 706-K. The parameters at the base station 702 include the bandwidth B₁ of the OFDM signals carried on the first carrier frequency, the SCS₁ of the subcarriers utilized by the base station 702, the number N₁ of the subcarriers (the size of the IFFT used to generate the OFDM signals).

Similarly, the parameters at the repeaters 706-1 . . . 706-K include the bandwidth B₂ of the OFDM signals carried on the second carrier frequency, the SCS₂ of the subcarriers utilized by the repeaters 706-1 . . . 706-K, the number N₂ of the subcarriers (the size of the IFFT used to generate the OFDM signals, and the mapping from \tilde{g}_{i,k} to m_{i,k}. Moreover, the beam information of the k′ repeater (e.g., quasi co-location information associated with the k^{th} repeater) at each TTI₂ may be indicated by the base station 702 for better decoding performance.

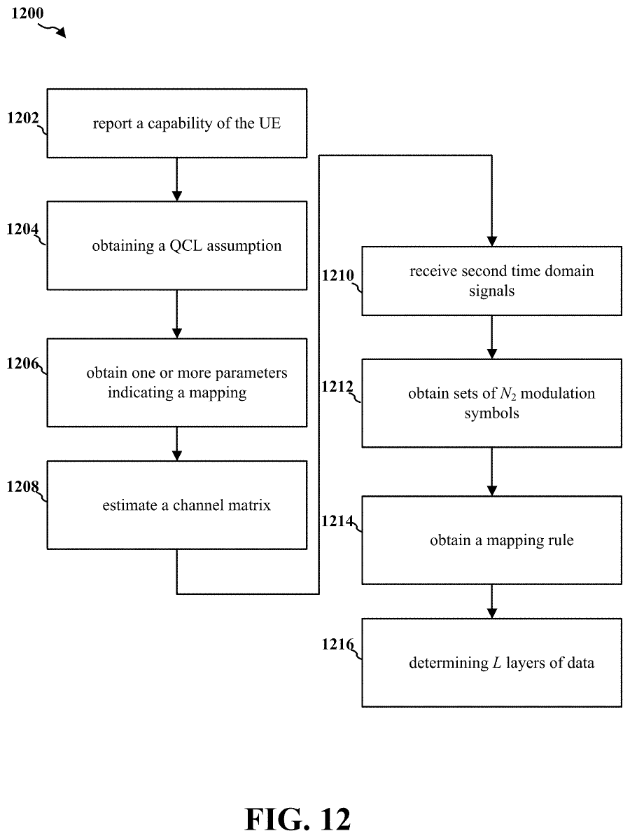

FIG. 12 is a flow chart 1200 of a method (process) for receiving data signals. The method may be performed by a UE (e.g., the UE 704). In certain configurations, at operation 1202, the UE reports a capability indicating a maximum value of L, meaning that the UE is capable of determining L layers of data based on sets of N₂ modulation symbols received in all of the S second intervals on the second frequency band. In certain configurations, at operation 1204, the UE obtains a quasi co-location (QCL) assumption for each of S second intervals, which may indicate parameters such as Doppler shift, Doppler spread, average delay, delay spread, or spatial receiving parameters for receiving the sets of N₂ modulation symbols in each second interval.

In certain configurations, at operation 1206, the UE obtains one or more parameters indicating a mapping used by the base station to map a set of N₁ modulation symbols on N₁ subcarriers of the first subcarrier spacing in a first OFDM symbol to a set of N₂ modulation symbols carried on N₂ subcarriers of the second subcarrier spacing in a second OFDM symbol received at the UE. In certain configurations, the first OFDM symbol is carried on a first frequency band and is contained in a first time domain signal transmitted from a base station, and the set of N₁ modulation symbols carries the L layers of data to be determined by the UE, while the set of N₂ modulation symbols are derived from the set of N₁ modulation symbols. In certain configurations, the one or more parameters indicate at least one of: a bandwidth, or a bandwidth upper bound, of the first OFDM symbol; the first subcarrier spacing; and a value of N₁.

In certain configurations, the UE obtains one or more parameters indicating a mapping used by the group of M wireless devices to map a set of N₁ modulation symbols received in a first OFDM symbol to a set of N₂ modulation symbols to be transmitted in a second OFDM symbol.

At operation 1208, the UE may estimate a channel matrix of a channel for receiving second time domain signals in each of the S second intervals based on reference signals received on the channel.

At operation 1210, the UE receives second time domain signals each carrying L layers of data through each of Nr receiving antennas on a second frequency band in S second intervals corresponding to a second subcarrier spacing. Each of the second intervals contains one or more OFDM symbols. The L layers of data are transmitted by a base-station through sets of N₁ modulation symbols carried on N₁ subcarriers of a first subcarrier spacing.

At operation 1212, the UE obtains sets of N₂ modulation symbols carried on N₂ reception subcarriers of the second subcarrier spacing from each second time domain signal received through each receiving antenna in each second interval.

Next, at operation 1214, the UE obtains a mapping rule that maps the sets of N₂ modulation symbols received in two or more of the S second intervals to a resource set for decoding together.

At operation 1216, the UE determines the L layers of data based on the sets of N₂ modulation symbols decoded together as mapped in the resource set. In certain configurations, the UE determines L1 layers data, out of the L layers of data, based on second time domain signals received in S1 second intervals out of the S second intervals and on estimated channel matrices corresponding to the S1 second intervals, where L1 and S1 are positive integers. In certain configurations, the UE determines the L layers data based on second time domain signals received in all of the S second intervals and estimated channel matrices corresponding to the S second intervals.

In certain configurations, the second time domain signals received in different intervals of the S second intervals being from different devices of a group of M wireless devices. In certain configurations, second time domain signals received in each of the S second intervals on the second frequency band corresponding to first time domain signals received at one of the group of M wireless devices in a first interval on a first frequency band. The second time domain signals represent sets of N₁ modulation symbols received at the one wireless device and carried on N₁ reception subcarriers of the first subcarrier spacing in the first interval, where the first interval and each second interval contain the same number of OFDM symbols of the first subcarrier spacing and the second subcarrier spacing, respectively.

In certain configurations, S equals to a ratio between the second subcarrier spacing and the first subcarrier spacing. In certain configurations, N₁ is no greater than N₂. In certain configurations, the first frequency band is in Frequency Range 1 and the second frequency band is in Frequency Range 2. In certain configurations, the S second intervals are subsequent to the first interval.

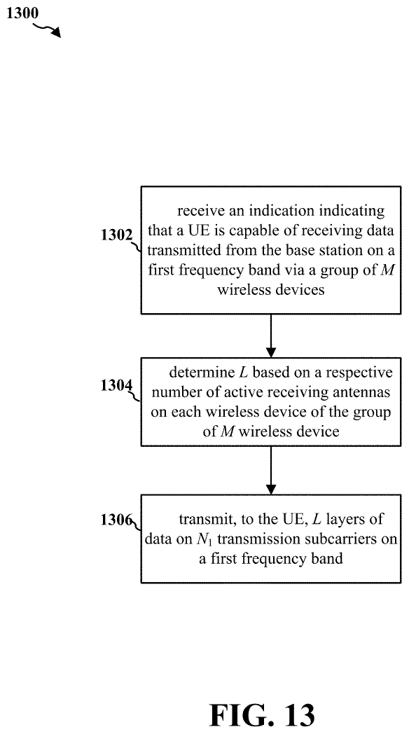

FIG. 13 is a flow chart 1300 of a method (process) for transmitting data via a group of M wireless devices. The method may be performed by a base station (e.g., the base station 702). At operation 1302, the base station receives an indication indicating that a user equipment (UE) is capable of receiving data transmitted from the base station on a first frequency band via a group of M wireless devices each transmitting data on N₂ transmission subcarriers on a second frequency band. At operation 1304, the base station determines L based on a respective number of active receiving antennas on each wireless device of the group of M wireless devices.

At operation 1306, the base station transmits, to the UE, L layers of data on N₁ transmission subcarriers on a first frequency band, where L is a positive integer and greater than Nᵣ, and Nᵣ is a number of receiving antennas that the UE is equipped with on the second frequency band. In certain configurations, N₁ is no greater than N₂. In certain configurations, the first frequency band is in Frequency Range 1 and the second frequency is in Frequency Range 2.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving second time domain signals each carrying L layers of data through each of Nᵣ receiving antennas of the UE on a second frequency band in S second intervals corresponding to a second subcarrier spacing, each of the second intervals containing one or more OFDM symbols, Nᵣ and L being positive integers, wherein the L layers of data are transmitted by a base-station through sets of N₁ modulation symbols carried on N₁ subcarriers of a first subcarrier spacing;
obtaining sets of N₂ modulation symbols carried on N₂ reception subcarriers of the second subcarrier spacing from each second time domain signal received through each receiving antenna of the UE in each second interval, wherein each set of the sets of N₂ modulation symbols is corresponding to one of the OFDM symbols in the S second intervals;
obtaining a mapping rule that maps the sets of N₂ modulation symbols received in two or more of the S second intervals to a resource set for decoding together; and
determining the L layers of data based on the sets of N₂ modulation symbols decoded together as mapped in the resource set.

2. The method of claim 1, further comprising:
reporting a capability of the UE indicating a maximum value of L, wherein the UE is capable of determining L layers of data based on sets of N₂ modulation symbols received at the UE in all of the S second intervals on the second frequency band, and the maximum value of L is larger than Nᵣ.

3. The method of claim 1, wherein second time domain signals received in different intervals of the S second intervals are from different devices of a group of M wireless devices.

4. The method of claim 1, further comprising:
obtaining a quasi co-location (QCL) assumption for each of the S second intervals, wherein the QCL assumption indicate at least one of a Doppler shift, a Doppler spread, an average delay, a delay spread, and a spatial receiving parameter for receiving the sets of N₂ modulation symbols in the each second interval.

5. The method of claim 1, further comprising:
obtaining one or more parameters indicating a mapping that is used by the base station to map a set of N₁ modulation symbols on N₁ subcarriers of the first subcarrier spacing in a first OFDM symbol to a set of N₂ modulation symbols carried on N₂ subcarriers of the second subcarrier spacing in a second OFDM symbol received at the UE, wherein the first OFDM symbol is carried on a first frequency band and is contained in a first time domain signal transmitted from a base station, wherein the set of N₁ modulation symbols carries the L layers of data to be determined by the UE, wherein the set of N₂ modulation symbols are derived from the set of N₁ modulation symbols.

6. The method of claim 5, wherein the one or more parameters indicate at least one of:
a bandwidth, or a bandwidth upper bound, of the first OFDM symbol,
the first subcarrier spacing, and
a value of N₁.

7. The method of claim 3, further comprising:
obtaining one or more parameters indicating a mapping that is used by the group of M wireless devices to map a set of N₁ modulation symbols received in a first OFDM symbol to a set of N₂ modulation symbols to be transmitted in a second OFDM symbol.

8. The method of claim 7, wherein the one or more parameters indicate at least one of:
a bandwidth, or a bandwidth upper bound, of the second OFDM symbol,
the second subcarrier spacing, and
a value of N₂.

9. The method of claim 3, wherein second time domain signals received in each of the S second intervals on the second frequency band correspond to first time domain signals received at one of the group of M wireless devices in a first interval on a first frequency band, the second time domain signals representing sets of N₁ modulation symbols received at the one wireless device and carried on N₁ reception subcarriers of the first subcarrier spacing in the first interval, where the first interval and each second interval contain a same number of OFDM symbols of the first subcarrier spacing and the second subcarrier spacing, respectively.

10. The method of claim 9, wherein S equals to a ratio between the second subcarrier spacing and the first subcarrier spacing.

11. The method of claim 9, wherein N₁ is no greater than N₂.

12. The method of claim 9, wherein the first frequency band is in Frequency Range 1 and the second frequency band in Frequency Range 2.

13. The method of claim 9, wherein the S second intervals are subsequent to the first interval.

14. The method of claim 1, further comprising:
estimating a channel matrix of a channel for receiving second time domain signals in each of the S second intervals based on reference signals received on the channel.

15. The method of claim 14, further comprising:
determining L₁ layers data, out of the L layers of data, based on second time domain signals received in S₁ second intervals out of the S second intervals and on estimated channel matrices corresponding to the S₁ second intervals, L₁ and S₁ being positive integers.

16. The method of claim 15, wherein Nᵣ*S₁ is no less than L₁.

17. The method of claim 14, further comprising:
determining the L layers data based on second time domain signals received in all of the S second intervals and estimated channel matrices corresponding to the S second intervals.

18. A method of wireless communication of a base station, comprising:
receiving an indication indicating that a user equipment (UE) is capable of receiving data transmitted from the base station on a first frequency band via a group of M wireless devices each transmitting data on N₂ transmission subcarriers on a second frequency band;
transmitting, to the UE, L layers of data on N₁ transmission subcarriers on a first frequency band, L being a positive integer and greater than Nᵣ, wherein Nᵣ is a number of receiving antennas that the UE is equipped with on the second frequency band.

19. The method of claim 18, further comprising:
determining L based on a respective number of active receiving antennas on each wireless device of the group of M wireless devices.

20. The method of claim 18, wherein N₁ is no greater than N₂.

21. The method of claim 18, wherein the first frequency band is in Frequency Range 1 and the second frequency is in Frequency Range 2.

22. An apparatus for wireless communication, the apparatus being a user equipment (UE), comprising:
a memory; and
at least one processor coupled to the memory and configured to:
receive second time domain signals each carrying L layers of data through each of Nᵣ receiving antennas of the UE on a second frequency band in S second intervals corresponding to a second subcarrier spacing, each of the second intervals containing one or more OFDM symbols, Nᵣ and L being positive integers, wherein the L layers of data are transmitted by a base-station through sets of N₁ modulation symbols carried on N₁ subcarriers of a first subcarrier spacing;
obtain sets of N₂ modulation symbols carried on N₂ reception subcarriers of the second subcarrier spacing from each second time domain signal received through each receiving antenna of the UE in each second interval, wherein each set of the sets of N₂ modulation symbols is corresponding to one of the OFDM symbols in the S second intervals;
obtain a mapping rule that maps the sets of N₂ modulation symbols received in two or more of the S second intervals to a resource set for decoding together; and
determine the L layers of data based on the sets of N₂ modulation symbols decoded together as mapped in the resource set.
